(19) United States
(12) Patent Application Publication
(10) Pub. No.: US 2002/0041916 A1
(43) Pub. Date: Apr. 11, 2002

(54) Method for distributed production of beer and restaurant services

(76) Inventor: William E. Burdick, Minnetonka, MN (US)

Correspondence Address: Craig M. Gregersen, BRIGGS AND MORGAN, 2200 First National Bank Building, 332 Minnesota Street, Saint Paul, MN, 55101, US

(21) Appl. No.: 09/777,159

(22) Filed: Feb. 5, 2001

Related U.S. Application Data
(60) Provisional application No. 60/238,606, filed on Oct. 10, 2000.

(51) Int. Cl. C12C 11/00

(52) U.S. Cl. 426/16

(57) ABSTRACT

The present invention calls for the establishment of a centralized facility for the production of unfermented, undiluted, and unprocessed hopped wort using a single source of water. The hopped wort is then cooled and transported to a plurality of remote fermentation sites where the hopped wort will be fermented into beer by the addition of yeast. The fermentation sites are preferably located within a restaurant to provide the diners with the aesthetic enjoyment of consuming beers fermented on the premises and to provide a consistent quality from one restaurant location to the next where such beers are produced.

### FIELD OF THE INVENTION

The present invention relates to the production of beer and the provision of restaurant services generally and to the distributed production of beer and distributed provision of restaurant services in particular.

### BACKGROUND OF THE INVENTION

The production of beer is old in the human arts, with some historians and anthropologists of the belief that it was the need to produce grain to ferment into beer that led to the establishment of civilization thousands of years ago.

In very general terms, the production of beer involves first producing a “sweet wort”. The sweet wort is formed by the addition of water to malted, and unmalted crushed grain, such as but not limited to barley, to form a slurry or mash in a mash tun. Through the action of naturally occurring enzymes this mash is then converted into the sweet wort. Subsequently, the liquid in the sweet wort is drained from the mash tun and directed to a brew kettle where hops are added. The hopped liquid is then boiled in the brew kettle to produce a “hopped wort.” The final step in the brewing process involves the addition of a yeast to cause fermentation to occur in a fermentation vessel, which in turn results in the production of alcohol.

Over the years, the foregoing general process has been tinkered with and altered by brewmasters to produce beers of differing flavors, coloring, clarity, and alcohol content. Differing pressures, temperatures, grains, yeasts, and fermentation times produce differing beers, which is inclusive of ales and lagers.

Along with the rise in the production and sale of fermented beverages came eventually the provision of restaurant services. The basic methods of providing restaurant services, including the sale of alcoholic beverages, has changed little in substance, though perhaps greatly in style, over the centuries.

Many restaurants, though not all, serve alcoholic beverages, including beers. Restaurants generally provide their customers with beer by purchasing finished product produced at a brewery, which is then shipped to a restaurant for sale, or, in a few instances, by producing the beer on site at the restaurant. The latter form of restaurant establishments are known as “brew-pubs” in the industry. In reality, the vast majority of beer is brewed by the major breweries and then transported to various restaurants and served either in individual containers or out of kegs. Some restaurants have made the large capital expenditures necessary to brew beer from start to finish on site, though their numbers are limited because of the cost involved in purchasing, operating, and maintaining a quality beer production facility in a restaurant. In addition, those restaurants that have made this investment find expansion difficult to achieve for several reasons, not the least of them being because of the cost involved in building new brewing facilities at a new location and the lack of skilled brewmasters to oversee the brewing process in the individual restaurants. Consequently, often times a successful restaurant offering on-site brewing as well as other restaurant services is unable to expand beyond a single restaurant because of the capital cost involved with establishing another on-site brewery and/or the lack of a brewmaster to oversee the brewing operation.

Another difficulty faced by brew-pubs in expanding their operations from a single site is that the quality of beer produced at varying locations can differ for a number of reasons, most prominent of them being the quality of water used to produce the beer at each site. That is, because water quality naturally varies from site to site, it is difficult—if not nearly impossible—and costly to produce a beer of the exact same taste and quality from brew-pub to brew-pub without costly processing of the local water at multiple location so as to remove it as a factor in the quality of the final product produced at each location.

Some brew-pubs have perhaps considered a central location for the production of all of their brewed product with shipment of the finished product from the central production facility to other locations, thus avoiding the issue of the large capital costs involved in setting up second and subsequent brewing facilities. A considerable difficulty of this approach, however, is the regulatory morass involved in the production and transport of alcoholic beverages in intrastate and interstate commerce.

The prior art discloses an interruption in the brewing process in U.S. Pat. No. 3,290,153 to Bayne, et al. In that patent, the brewing process is discontinued after the production of the hopped wort. The hopped wort is then concentrated by passing it through continuous film evaporators to produce a wort concentrate having a solids content of about 80%. Following concentration, the wort is cooled to a temperature below 105° F. The patent then notes that the wort concentrate can be stored on site or shipped elsewhere for subsequent reconstitution and fermentation. It is unclear whether this method was ever actually implemented, but in any event, this production method is rife with difficulty, however, not the least of which is that the taste, color, etc. of beer is greatly dependent upon the quality of water used in the production of the final product. Thus, the production of beer at a different location from where the wort was originally produced using this process is subject to the production of beer of varying quality and taste at the various final production facilities or to great cost to neutralize the effect of the local water quality. In addition, the cost of producing the wort concentrate is itself expensive in that it requires multiple evaporators or equivalent equipment to produce the concentrated wort.

It would be desirable to have a process for the distributed production of beer and restaurant services to eliminate the foregoing deficiencies in the provision of beer and restaurant services.

### SUMMARY OF THE INVENTION

It is an object of the present invention to provide new and improved methods of beer production that is not subject to the foregoing disadvantages.

It is another object of the present invention to provide a quality beer product that is finish brewed at a plurality of restaurant locations at a favorable cost of production.

It is still another object of the present invention to provide a method for production of a quality beer product originally brewed on-site at a plurality of locations using a single source for the production of the hopped wort.

It is yet another object of the present invention to provide a method for a brew-pub to produce a quality beer product at a plurality of locations without incurring full infrastructure costs for beer production at each location.

It is still yet another object of the present invention to enable a brew-pub chain to produce a beer of singular quality at each of its restaurants.

It is yet another object of the present invention to enable a brew-pub chain to produce a beer of singular quality at each of its restaurants without regard to local variations in water quality used in the production of beer.

It is another object of the present invention to provide a method for a brew-pub to expand from a single location to one or more additional locations while still being able to produce and sell beer brewed on site without sacrificing quality in the brewed product and without being subject to various state and federal regulations regarding the production and shipment of alcoholic beverages.

The foregoing objects of the present invention are provided by a method for distributed restaurant services and beer production. The present invention provides for establishing a first of a plurality of restaurants with the first restaurant including the necessary equipment to brew beer from start to finish and being generally capable of producing more hopped wort than the first restaurant necessarily needs, presuming normal patronage, for fermenting into beer for onsite sales. The excess capacity hopped wort is cooled and then the unconcentrated, unadulterated hopped word is transported to at least a second restaurant where the hopped wort is placed within a fermentation vessel for the addition of yeast to begin and complete the fermentation process.

More generally, the present invention calls for the establishment of a centralized facility for the production of unfermented, undiluted, and unprocessed hopped wort using a single source of water. This hopped wort is then cooled and transported to a plurality of remote fermentation sites where the hopped wort will be fermented into beer by the addition of yeast. The fermentation sites are preferably located within a restaurant to provide the restaurant customers with the aesthetic enjoyment of consuming beers fermented on the premises and to provide a consistent quality from one restaurant location to the next where such beers are produced.

The foregoing objects of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWING

FIG. 1 illustrates a flow chart showing a method for the production of beer in accord with the present invention.

### DETAILED DESCRIPTION OF THE INVENTION

The present invention provides for an discontinuation of the brewing process after the production of the hopped wort. The hopped wort is then transported to another location where the brewing process is completed. In other words, the present invention provides for beginning the beer production process at one facility and finishing at another facility remote from the first without sacrificing quality in the final product and without incurring multiple infrastructure costs at each location.

The general steps for the production of beer are well known, as set forth above. A method of producing beer according to the present invention includes completing the boil of the hopped wort in the brew kettle at the first facility. Upon completion of the boil of the hopped wort, the hopped wort will be chilled from its boiling temperature to between about 32° F. (0° C.) and about 38° F. (about 3° C.), and preferably about 36° F. (2.2° C.). There are many methods available for cooling such a liquid, such as passing it through a heat exchanger to remove the heat and then placing it in a cold wort storage vessel. The hopped wort could be chilled either in situ in the storage vessel or could undergo in-line cooling in well known manner as the liquid is transferred from the brew kettle to the storage vessel. Cooling of the hopped wort is desirable since bacterial action will be substantially, if not totally, inhibited.

After the hopped wort has been sufficiently cooled, it will be substantially held at the desired temperature range until it has been transported to one of the remote brewing sites. Depending upon the distance between the central facility and the remote fermenter, refrigeration of the wort may not be necessary since the hopped wort will warm only slightly over short transportation distances when transported in an insulated container. Where substantial distances are involved, however, it may be desirable to refrigerate the hopped wort during transport to maintain the desired temperature range and thus inhibit microbial activity from occurring in the hopped wort.

Upon arrival at the remote brewing site, the temperature of the hopped wort will be raised to the appropriate fermentation temperature either within or prior to transferring it to a fermentation vessel or fermenter. It will be understood that the “appropriate fermentation temperature” will vary based upon the beer being produced, which in turn is dependent upon the yeast being used in the fermentation process. Different yeasts, as is well known in the brewing arts, will ferment at different temperatures. Generally, however, the temperature will be raised to within in range of about 48° F. (about 9° C.) to about 74° F. (about 23° C.).

The hopped wort can be warmed to the appropriate temperature for the particular product being produced by use of in-line heaters between the transport vessel and the fermentation vessel at the second location. Alternatively, the hopped wort can be warmed in the fermentation vessel.

Once in the fermentation vessel and heated to the appropriate temperature for the particular yeast to be added, the yeast will be added and the fermentation process will begin

The present invention also provides a method for providing distributed restaurant services including the service of fermented-on-site beers. In a method in accord with the present invention, a centralized hopped wort production facility is established, which may be within an established restaurant. A hopped wort is produced at the centralized facility and then cooled and transported all as previously described to remote restaurant sites providing restaurant services comprising serving food and beverages including beer. The appropriate yeast will then be added to the rewarmed hopped wort at the remote restaurant site and the hopped wort will be fermented into beer.

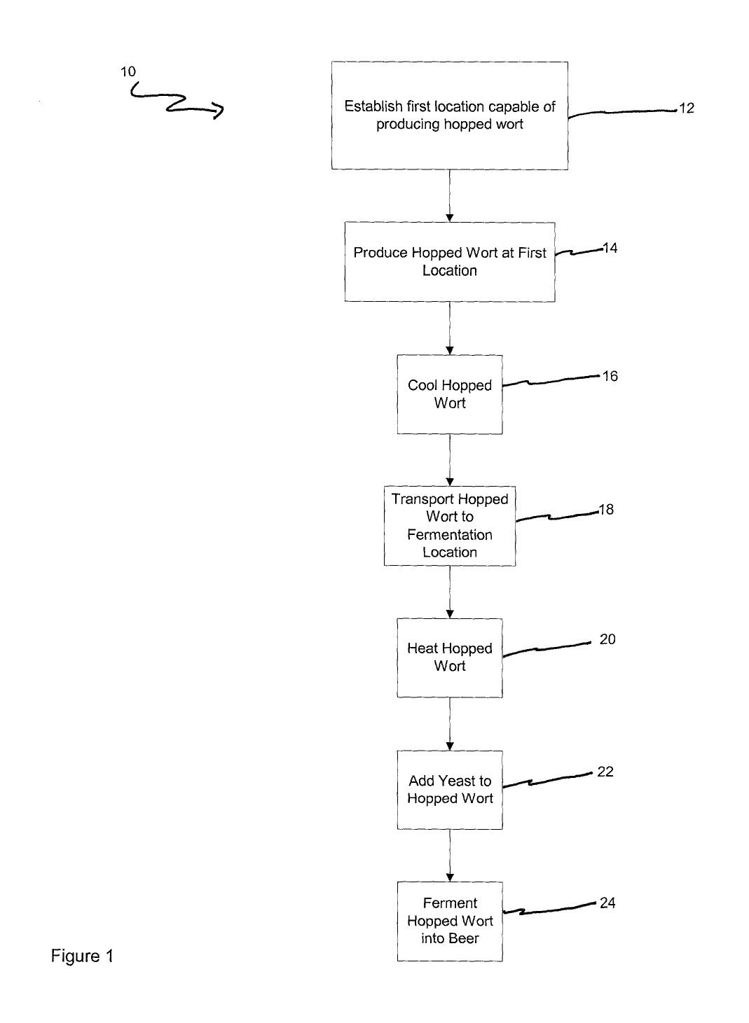

Referring to FIG. 1, the present invention will be described with reference to the process flow chart shown there. Thus, FIG. 1 illustrates a method 10 for the distributed production of a quality beer product that is substantially independent of the quality of the local water source at the secondary production facilities. Method 10 contemplates establishing a first production facility as indicated at 12, such as a restaurant providing restaurant services, with the facility including the necessary and well-known equipment for the production of beer from start to finish. Additionally, the first production facility will be able to produce hopped wort at a capacity over and above what would normally be expected to be fermented into beer and sold on the premises. The present invention contemplates that the production of the hopped wort will be carried out in the normal course of beer production at the first facility as indicated at 14, preferably under the direction of a skilled brewmaster.

Once a batch of hopped wort has been produced, a preselected amount of the hopped wort batch can be drawn off and quickly cooled from its boiling point to a temperature below which microbial activity can normally be expected to occur, that is, within the range of between about 32° F. (0° C.) and about 38° F. (about 3° C.), and preferably about 36° F. (about 2.2° C.), as indicated at 16. It will be understood that the production of the hopped wort, which involves boiling, will destroy most microbes present in the hopped liquid prior to boiling. By rapidly cooling the hopped wort, microbial production is slowed if not completely prevented, during transport to the fermentation facility at a remote location.

The hot wort can be cooled as indicated at 16 in any known manner useful for cooling hot fluids. For example, the output lines from the wort kettle may be jacketed with a cooling line. Alternatively, the hopped wort could be transferred to an appropriately designed cooling vessel known in the art for cooling to the desired temperature range.

Once cooled, the hopped wort can be loaded into a storage vessel disposed on any known form of transport capable of transporting fluids in sterile or near sterile conditions. The hopped wort can then be transported as indicated at 18 to a remote or distributed site. Typically the storage vessels used in liquid transport are insulated, preventing substantial temperature changes in the fluid. Thus, if the final production facility for which the hopped wort is destined is nearby, further efforts to maintain the temperature of the hopped wort within the range of between about 32° F. (0° C.) and about 38° F. (about 3° C.) will be unnecessary. Where, however, the wort is to be transported a considerable distance, or where environmental factors such as the ambient temperature would so indicate, the storage vessel could also be refrigerated in any well known manner so as to maintain the hopped wort within the acceptable transport temperature range.

Following the arrival of the hopped wort at the remote, final production facility, which may be another restaurant as previously noted, the hopped word will be offloaded from the transport vessel into a fermentation vessel. Either prior to offloading, during the transfer to the fermenter, or after being received in the fermentation vessel, the hopped wort will be warmed as indicated at 20 to the appropriate fermentation temperature for the final step in the beer production process—fermentation. As noted previously, different beers ferment at different temperatures. Generally, however, the hopped wort will need to be warmed to a temperature within the range of about 48° F. (about 9° C.) to about 74° F. (about 23° C.) as indicated above. Once the hopped wort is at the proper temperature and is now in the fermentation vessel depending upon where the warming occurred, the proper yeast can be added to the hopped wort as indicated at 22 to begin the fermentation process as indicated at 24.

Following the normal fermentation for the particular type of beer desired to be produced, the newly on-site-produced beer is aged in maturation vessels and then is served to the restaurant's customers. Because there is no or very little local water that would need to be added during the fermentation process, the present invention of providing restaurant services is essentially independent of local water quality and thus the beer finally produced at the remote locations will have substantially the same taste and color and be of the same quality as that produced at the production facility which produced the hopped wort.

The present invention enables a restaurateur to expand the number of restaurant sites that offer a particular decor, menu, and on-site brewed beverages of identical taste and quality while reducing the amount of capital involved to do so and the need to rely on a skilled brewmaster at each location where the beverages are fermented. That is, with the present invention, a single brewmaster can maintain control of the production of the hopped wort at the central facility as well as individually oversee or properly train employees to oversee the fermentation process at the individual restaurants where the fermentation takes place. In addition, because the hopped wort does not contain alcohol, the production and transport of the hopped wort does not implicate state and federal laws and regulations regarding the production, sale, and distribution of alcoholic beverages, thus eliminating administrative and legal costs associated with compliance with those laws and regulations.

More generally still, the present invention provides a new method of producing beer comprising, first, cooling a hopped wort produced at a first location, which could be a centralized production facility, to a temperature in the range of about 32° F. to about 38° F.; second, transporting the unconcentrated, unadulterated hopped wort to a second location remote from the first location, the second location being a brewpub, restaurant, bar, or any other establishment capable of fermenting the hopped wort into beer; and, third, fermenting the hopped wort into beer at the second location. The present invention is distinct over the prior art techniques of producing beer in that the prior art beer production process is interrupted before the yeast is added to the hopped wort and instead the hopped wort is first transported to a second location remote from the first in any known manner, such as by trucks having refrigerated vessels for fluid transport and then the yeast is subsequently added at a new fermentation location.

The present invention having thus been described, other modifications, alterations, or substitutions may now suggest themselves to those skilled in the art, all of which are within the spirit and scope of the present invention. It is therefore intended that the present invention be limited only by the scope of the attached claims below.

What is claimed is:

1. A method for the distributed production of beer comprising:
cooling a hopped wort to a temperature in the range of about 32° F. to about 38° F. at a first location;
transporting the unconcentrated hopped wort to a second location remote from the first location; and
fermenting the hopped wort into beer at the second location.

2. The method of claim 1 wherein the hopped wort is cooled by passing it through a heat exchanger.

3. The method of claim 2 and further including:
raising the temperature of the hopped wort at the second location to temperature in the range of about 48° F. to about 74° F.

4. The method of claim 3 and further including adding yeast to the hopped wort to enable the hopped wort to ferment.

5. The method of claim 1 and further including:
raising the temperature of the hopped wort at the second location to temperature in the range of about 48° F. to about 74° F.

6. The method of claim 5 and further including adding yeast to the hopped wort to enable the hopped wort to ferment.

7. The method of claim 1 wherein said second location is an establishment that serves beer.

8. The method of claim 7 wherein the establishment is a restaurant.

9. The method of claim 8 wherein the first location is a restaurant which has a wort production facility.

10. A method for the provision of distributed restaurant services, said services including the on-site fermentation and production of an alcoholic product, said method comprising:
establishing a first restaurant location, said restaurant for providing restaurant services including the production and sale of beer;
producing hopped wort at the first restaurant location;
transporting the hopped wort to a second restaurant location remote from the first restaurant location; and
fermenting the hopped wort into beer at the second restaurant location.

11. The method of claim 10 wherein said method includes:
cooling said hopped wort to a temperature in the range of about 32° F. to about 38° F. at said first restaurant location.

12. The method of claim 11 wherein the hopped wort is cooled by passing it through a heat exchanger.

13. The method of claim 11 and further including:
raising the temperature of the hopped wort at the second restaurant location to temperature in the range of about 48° F. to about 74° F.

14. The method of claim 13 and further including adding yeast to the hopped wort at the second restaurant location to enable the hopped wort to ferment.

15. The method of claim 11 and further including:
raising the temperature of the hopped wort at the second restaurant location to temperature in the range of about 48° F. to about 74° F.

16. The method of claim 15 and further including adding yeast to the hopped wort at the second restaurant location to enable the hopped wort to ferment.
